(19) United States
(12) Patent Application Publication
(10) Pub. No.: US 2026/0160356 A1
(43) Pub. Date: Jun. 11, 2026

(54) VALVE

(71) Applicant: KANE KOGYO Co., Ltd., Aichi (JP)

(72) Inventor: Masaru OCHIAI, Aichi (JP)

(21) Appl. No.: 19/180,493

(22) Filed: Apr. 16, 2025

(30) Foreign Application Priority Data
Apr. 22, 2024 (JP) 2024-068871

(51) Int. Cl. F16K 31/126; F16K 31/122; F16K 31/20

(52) U.S. Cl. CPC F16K 31/1266; F16K 31/1221; F16K 31/1223; F16K 31/1262; F16K 31/20

(57) ABSTRACT

By a valve stem 10 having an upper end part penetrating through a piston 9 inside a cylinder 4 and fixed to a pressure displacement means 12 and having a lower end portion to which is fixed a valve main element 11 disposed inside a secondary flow path 3 and forming a secondary side communication flow path 16 in the valve stem, it is made possible, without forming of the secondary side communication flow path in the valve body 1, to feed a fluid at the secondary flow path side into a pressure sensing chamber 14 via the secondary side communication flow path of the valve stem in accordance with pressure rise at the secondary side and made possible to make an appropriate selection among valve stems differing in diameters of the hollow portion 13 and the supply hole 15 that constitute the secondary side communication flow path.

### TECHNICAL FIELD

The present invention relates to a valve of a form in which a secondary flow path and a space portion formed below a pressure displacement means such as a diaphragm are put in communication by a secondary side flow path.

### BACKGROUND ART

Conventionally, as a typical example of such a valve, a pressure reducing valve can be cited and this pressure reducing valve is a valve with which a secondary side end of a primary flow path and a primary side end of a secondary flow path are disposed vertically with a valve port formed in a partition wall disposed therebetween and is generally of a form where an opening degree of a valve main element is made controllable in accordance with pressure variation in the secondary flow path and a space portion formed below a pressure displacement means, for example, a diaphragm and the secondary flow path are put in communication by a secondary side communication flow path formed at a valve body side (see, for example, Patent Literature 1).

### CITATION LIST

### Patent Literature

[Patent Literature 1] Japanese Patent Application Publication No. 2001-147724

### SUMMARY OF INVENTION

### Technical Problem

However, with the prior art described above, there are problems to be solved such as that the valve body is generally made by casting and thus forming of the secondary side communication flow path in the valve body invites complication of the structure of the valve body and furthermore, a diameter, etc. of the secondary side communication flow cannot be changed after manufacture, etc.

### Solution to Problem

In view of the problems, based on the above-described prior art, of complication of the structure of the valve body and inability to adjust the secondary side communication flow path, the present invention is a valve having a valve body that has a primary flow path and a secondary flow path formed in an interior and includes a cylinder and a case housing a pressure displacement means, a valve port being formed in a partition wall disposed between the primary flow path and the secondary flow path, a valve mechanism portion penetrating through an interior of the cylinder, the valve mechanism portion including a piston that is housed reciprocally slidably inside the cylinder, a valve stem that penetrates through the piston, a valve main element through a center of which penetrates a lower end portion of the valve stem that has penetrated through the valve port, and the pressure displacement means to which is fixed an upper end portion of the valve stem, and the valve having a secondary side communication flow path that puts a pressure sensing chamber formed below the pressure displacement means in communication with one of either the primary flow path or the secondary flow path and solves the above problems by the valve stem having a downwardly open hollow portion of cylindrical shape, a supply hole that puts the hollow portion and the pressure sensing chamber in communication being formed at an upper end side of the valve stem, and the secondary side communication flow path being formed with the supply hole and the hollow portion to enable, without forming of the secondary side communication flow path in the valve body, feeding of a fluid at the secondary flow path side into the pressure sensing chamber via the secondary side communication flow path of the valve stem in accordance with pressure rise at a secondary side and enable appropriate selection among valve stems differing in diameters of the hollow portion and the supply hole to enable adjustment of the secondary side communication flow path.

### Effects of Invention

In other words, since the present invention is the valve having the valve body that has the primary flow path and the secondary flow path formed in the interior and includes the cylinder and the case housing the pressure displacement means, the valve port being formed in the partition wall disposed between the primary flow path and the secondary flow path, the valve mechanism portion penetrating through the interior of the cylinder, the valve mechanism portion including the piston that is housed reciprocally slidably inside the cylinder, the valve stem that penetrates through the piston, the valve main element through the center of which penetrates the lower end portion of the valve stem that has penetrated through the valve port, and the pressure displacement means to which is fixed the upper end portion of the valve stem, and the valve having the secondary side communication flow path that puts the pressure sensing chamber formed below the pressure displacement means in communication with the secondary flow path, in which the valve stem has the downwardly open hollow portion of cylindrical shape, the supply hole that puts the hollow portion and the pressure sensing chamber in communication is formed at the upper end side of the valve stem, and the secondary side communication flow path is formed with the supply hole and the hollow portion, a function as a pressure reducing valve or a constant flow rate valve can be provided without providing a particular function at the valve body side and furthermore, since the valve stem is exchangeable, a diameter of the secondary side communication flow path, etc. can be changed even after manufacture by exchanging with a valve stem differing in dimensions of the hollow portion and the supply hole.

A primary side communication flow path that puts the pressure sensing chamber and the primary flow path in communication is formed in the valve body and therefore, although the primary side communication flow path must be formed in the valve body, since the secondary side communication flow path is formed in the valve stem, substantially the same effects as the effects described above are provided and additionally, since, by putting the primary side communication flow path formed in the valve body and the secondary side communication flow path formed in the valve stem in communication via the pressure sensing chamber, a fluid in the primary flow path can be made to flow into the secondary flow path via the primary side communication flow path, the pressure sensing chamber, and the secondary side communication flow path, the practical effects such as enabling a pilot-valve-like function to be provided in a direct action type valve, etc. are exceedingly high.

### BRIEF DESCRIPTION OF DRAWINGS

FIG. 1 is a schematic sectional view of a diaphragm type valve of Example 1 of a valve according to the present invention.

FIG. 2 is a schematic sectional view of a piston type valve of Example 2 of the valve according to the present invention.

FIG. 3 is a schematic sectional view of a valve having a forced valve closing function that is Example 3 of the valve according to the present invention.

FIG. 4A is a schematic sectional view showing an open valve state of a float type valve that is Example 4 of the valve according to the present invention.

FIG. 4B is a schematic sectional view showing a closed valve state of the float type valve of FIG. 4A.

### DESCRIPTION OF EMBODIMENTS

A valve body 1 of a valve according to the present invention is made of metal or resin, etc. and particularly generally made by casting and basically has a primary flow path 2 and a secondary flow path 3 formed in an interior and has a cylinder 4 and a case 5 that houses a pressure displacement means 12 to be described later with an inner diameter of the case 5 being made greater than an inner diameter of the cylinder 4, a boundary portion being arranged as a step portion 5a, and a valve port 7 formed in a partition wall 6 disposed between the primary flow path 2 and the secondary flow path 3.

A valve mechanism portion 8 that penetrates through an interior of the cylinder 4 includes a piston 9 reciprocally slidably housed inside the cylinder 4, a valve stem 10 penetrating through the piston 9, a valve main element 11 disposed inside the secondary flow path 3 and through a center of which penetrates a lower end portion of the valve stem 10 that has penetrated through the valve port 7, and a pressure displacement means 12 housed inside the case 5 and to which an upper end portion of the valve stem 10 is fixed.

The valve stem 10 has a secondary side communication flow path 16 constituted of a downwardly open hollow portion 13 and a supply port 15 opening at a side surface near an upper end and makes a pressure sensing chamber 14 formed, below the pressure displacement means 12, inside the case 5 and the secondary flow path 3 communicable through the secondary side communication flow path 16.

A cover 17 is attached to an upper portion of the case 5 and a lower urging means 18 such as spring, etc. for the pressure displacement means 12 is provided inside the cover 17.

### EXAMPLE 1

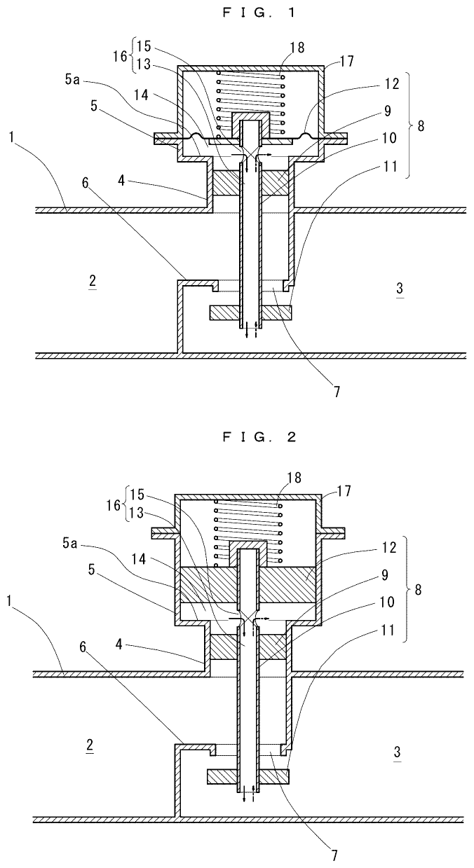

FIG. 1 is a schematic sectional view of a diaphragm type valve that is Example 1 of the valve according to the present invention with the pressure displacement means 12 being arranged as a diaphragm with an outer peripheral portion being clamped by the case 5 and the cover 17.

### EXAMPLE 2

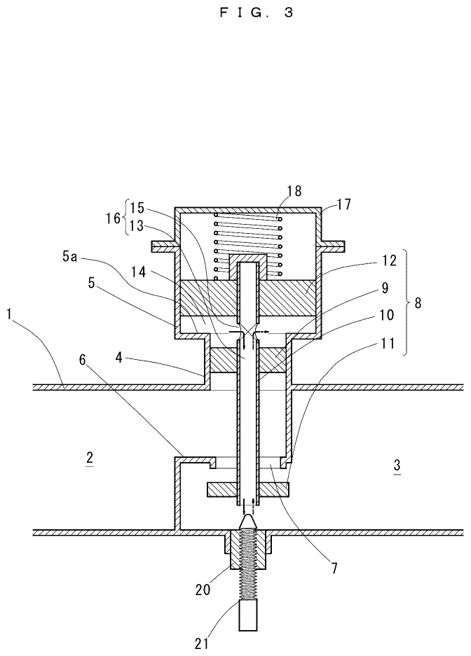

FIG. 2 is a schematic sectional view of a piston type valve that is Example 2 of the valve according to the present invention with the pressure displacement means 12 arranged as a piston that is housed reciprocally slidably inside the case 5.

And in case of use as a pressure reducing valve or a constant flow rate valve, in operation, the lower urging means 18 (spring) is adjusted such as to achieve a predetermined opening degree, a fluid of predetermined pressure or predetermined flow rate is fed to the secondary flow path 3 side, and by the fluid at the secondary flow path 3 side being fed into the pressure sensing chamber 14 via the secondary side communication flow path 16 (the hollow portion 13 and the supply hole 15) of the valve stem 10 in accordance with pressure rise at the secondary side, the diaphragm (the pressure displacement means 12) is deformed in the case of Example 1 or the piston (the pressure displacement means 12) is raised in the case of Example 2 such that the pressure sensing chamber 14 spreads and accordingly, the valve main element 11 rises, the opening degree of the valve port 7 narrows, and the pressure at the secondary side is decreased to a set value.

### EXAMPLE 3

FIG. 3 is a schematic sectional view of a valve having a forced valve closing function that is Example 3 of the valve according to the present invention and although the configuration is basically the same as Example 2, a plunger 20 is installed at a part opposing the cylinder 4 at a lower portion of the valve body 1 and the plunger 20 has a spindle 21 disposed on the same axis as the valve stem 10 and is enabled to open and close a lower opening portion of the valve stem 10 by upward/downward movement of the spindle 21 and enabled to shut off the valve port 7 with the valve main element 11 by forcibly moving the valve stem 10 upward by upward movement of the spindle 21.

In a pressure test, the valve main element 11 is set to a most lowered state such that the pressure displacement means 12 is seated on the step portion 5a and the pressure sensing chamber 14 is eliminated below the pressure displacement means 12 and the lower opening portion of the valve stem 10 is put in a state of being shut off by the spindle 21 of the plunger 20, the pressure sensing chamber 14 will not be formed even when a fluid pressure acts.

In case of use as a flow control valve, valve main element 11 can be maintained at the predetermined opening degree by putting a tip of the spindle 21 of the plunger 20 in contact with the lower end portion of the valve stem 10.

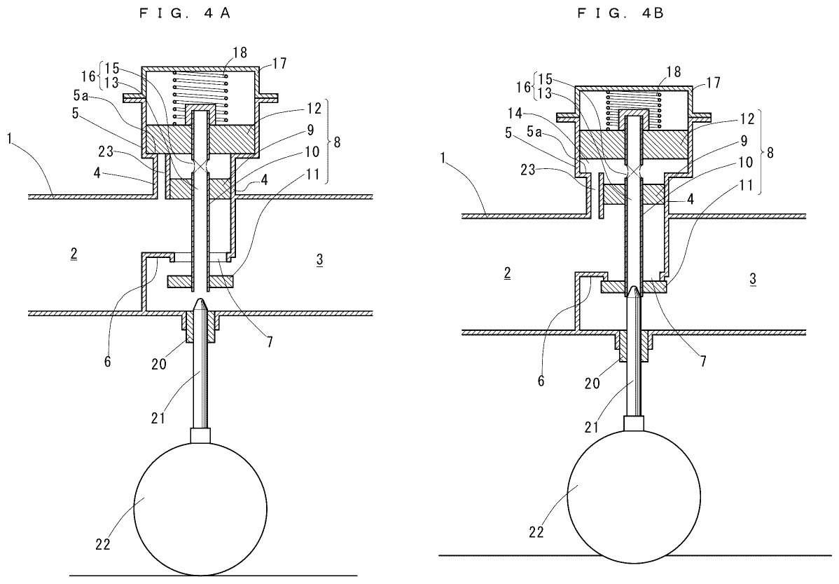

### EXAMPLE 4

Whereas in Examples 1 to 3, just the secondary side communication flow path 16 is communicable with the pressure sensing chamber 14, Example 4 is a valve with which the pressure sensing chamber 14 and the secondary flow path 3 are made communicable by the secondary side communication flow path 16 and the pressure sensing chamber 14 and the primary flow path 2 are made communicable by a primary side communication flow path 23 formed in the valve body 1, and FIG. 4A is a schematic sectional view showing an open valve state of a float type valve that is an example of Example 4 of the valve according to the present invention, FIG. 4B is a schematic sectional view showing a closed valve state of the float type valve of FIG. 4A, and although having the plunger 20 as in Example 3, a float 22 is connected to a base end portion of the spindle 21 and the primary side communication flow path 23 opens at the step portion 5a.

Further, as shown in FIG. 4A, with the valve main element 11 being in the most lowered state, the opening degree of the valve port 7 is maximum, the pressure displacement means 12 is seated on the step portion 5a, the primary side communication flow path 23 is shut off, the pressure sensing chamber 14 is eliminated below the pressure displacement means 12, and the lower opening portion is in an open state with the tip of the spindle 21 being in a separated state from the lower end portion of the valve stem 10, and when passage of water is started, first, just the float 22 and the spindle 21 rise, the tip of the spindle 21 contacts the lower end portion of the valve stem 10 and closes the lower opening portion, the secondary side communication flow path 16 (the hollow portion 13 and the supply hole 15) and the secondary flow path 3 are put in a non-communicating state, the valve stem 10, the valve main element 11, and the pressure displacement means 12 also rise together with the float 22 and the spindle 21, the pressure sensing chamber 14 is formed and widens gradually accordingly, the primary flow path 2 and the pressure sensing chamber 14 are put in a communicating state by the primary side communication flow path 23, and ultimately, the valve port 7 is shut off by the valve main element 11 and the passage of water is stopped as shown in FIG. 4B.

When the water level drops, first, just the float 22 and the spindle 21 begin to descend accordingly, and by the lower opening portion of the valve stem 10 opening, the primary flow path 2 and the secondary flow path 3 are put in a communicating state via the primary side communication flow path 23, the pressure sensing chamber 14, and the secondary side communication flow path 16, and then the valve stem 10, the valve main element 11, and the pressure displacement means 12 descend, the valve port 7 opens, and the passage of water is started.

### REFERENCE SIGNS LIST

1 Valve body
2 Primary flow path
3 Secondary flow path
4 Cylinder
5 Case
5a Step portion
6 Partition wall
7 Valve port
8 Valve mechanism portion
9 Piston
10 Valve stem
11 Valve main element
12 Pressure displacement means
13 Hollow portion
14 Pressure sensing chamber
15 Supply hole
16 Secondary side communication flow path
17 Cover
20 Plunger
21 Spindle
22 Float
23 Primary side communication flow path

1. A valve comprising a valve body that has a primary flow path and a secondary flow path formed in an interior and includes a cylinder and a case housing a pressure displacement means, a valve port being formed in a partition wall disposed between the primary flow path and the secondary flow path, a valve mechanism portion penetrating through an interior of the cylinder, the valve mechanism portion including a piston that is housed reciprocally slidably inside the cylinder, a valve stem that penetrates through the piston, a valve main element through a center of which penetrates a lower end portion of the valve stem that has penetrated through the valve port, and the pressure displacement means to which is fixed an upper end portion of the valve stem, and the valve comprising a secondary side communication flow path that puts a pressure sensing chamber formed, below the pressure displacement means, inside the case in communication with the secondary flow path wherein the valve stem has a downwardly open hollow portion of cylindrical shape, a supply hole that puts the hollow portion and the pressure sensing chamber in communication is formed at an upper end side of the valve stem, and the secondary side communication flow path is formed with the supply hole and the hollow portion.

2. The valve according to claim 1, wherein the pressure displacement means is a diaphragm whose outer peripheral portion is clamped by the case and a cover that is attached to an upper portion of the case.

3. The valve according to claim 1, wherein the pressure displacement means is a piston that is housed reciprocally slidably inside the case.

4. The valve according to claim 1, wherein a plunger is installed at a part opposing the cylinder at a lower portion of the valve body, a spindle of the plunger is disposed on the same axis as the valve stem, the plunger is enabled to open and close a lower opening portion of the valve stem by upward/downward movement of the spindle, and the plunger is enabled to shut off the valve port with the valve main element by forcibly moving the valve stem upward by upward movement of the spindle.

5. The valve according to claim 1, wherein a primary side communication flow path that puts the pressure sensing chamber and the primary flow path in communication is formed in the valve body.

6. The valve according to claim 5, wherein a plunger is installed at a part opposing the cylinder at a lower portion of the valve body, a spindle of the plunger is disposed on the same axis as the valve stem, a float is connected to a base end portion of the spindle, an inner diameter of the case is greater than an inner diameter of the cylinder, and the primary side communication flow path is opened at a step portion arranged at a boundary portion.

7. The valve according to claim 2, wherein a plunger is installed at a part opposing the cylinder at a lower portion of the valve body, a spindle of the plunger is disposed on the same axis as the valve stem, the plunger is enabled to open and close a lower opening portion of the valve stem by upward/downward movement of the spindle, and the plunger is enabled to shut off the valve port with the valve main element by forcibly moving the valve stem upward by upward movement of the spindle.

8. The valve according to claim 3, wherein a plunger is installed at a part opposing the cylinder at a lower portion of the valve body, a spindle of the plunger is disposed on the same axis as the valve stem, the plunger is enabled to open and close a lower opening portion of the valve stem by upward/downward movement of the spindle, and the plunger is enabled to shut off the valve port with the valve main element by forcibly moving the valve stem upward by upward movement of the spindle.
